(19) United States
(12) Patent Application Publication
(10) Pub. No.: US 2004/0149592 A1
(43) Pub. Date: Aug. 5, 2004

(54) Electropolishing apparatus and polishing method

(75) Inventors: Naoki Komai, Kanagawa (JP); Zenya Yasuda, Kanagawa (JP); Shuzo Sato, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation

(21) Appl. No.: 10/762,691

(22) Filed: Jan. 22, 2004

(30) Foreign Application Priority Data
Jan. 24, 2003 (JP) 2003-015928

(51) Int. Cl. B23H 3/00

(52) U.S. Cl. 205/663

(57) ABSTRACT

Disclosed herein is an electropolishing apparatus including a polishing surface plate including a cathode and disposed turnably, a polishing pad disposed on the polishing surface plate, to be impregnated with an electropolishing liquid, and showing electric conduction from the face side to the back side thereof in the state of being impregnated with the electropolishing liquid, a substrate holding unit for holding a work substrate with a work surface of the work substrate opposed to a polishing surface of the polishing pad, the substrate holding unit turnably disposed at a position opposed to the polishing pad, an anode brought into contact with the work surface of the work substrate held by the substrate holding unit, a chemical liquid supply unit for supplying a chemical liquid used for polishing onto the polishing pad, and a power source for supplying electric power between the cathode and the anode.

### BACKGROUND OF THE INVENTION

The present invention relates to an electropolishing apparatus and a polishing method, and particularly to an electropolishing apparatus and a polishing method for polishing a metallic film or metallic compound film formed on a semiconductor substrate.

An ordinary electropolishing apparatus generally has a structure in-which the work to be polished and a counter electrode (cathode) disposed at a position opposed to the work are immersed in a large vessel filling an electrolytic liquid and the work is polished. In addition, for mirror finish or for improvement of step characteristics such as undulation, a technique called composite electropolishing has been proposed. Various types of the composite electropolishing include a method of conducting polishing while discharging an electropolishing liquid from the counter electrode (see, for example, Japanese Patent Laid-open No. 2001-196335 [pp. 6 to 7, FIG. 2]), an electropolishing apparatus in which the surface of a metallic film is subjected to anodic oxidation by electrolysis to be brought into an ionic state and the anodically oxidized metallic film is removed by wiping with a wiper (see, for example, Japanese Patent Laid-open No. 2002-254248 [pp. 12 to 15, FIGS. 6 to 7]), and a method of sequentially conducting primary polishing by use of an electrolytic current and abrasive grains and secondary polishing by use of an electrolytic current (see, for example, Japanese Patent No. 3125049 [pp. 2 to 4, FIGS. 1 to 8]). In each of these cases, the system does not include a structure for positively discharging the electropolishing slurry having contributed to polishing or a structure for individually controlling the electrolytic liquid, free abrasive grains, and pure water used for cleaning.

However, in the polishing apparatus in which the electrolytic liquid is supplied from the counter electrode side as described in Japanese Patent Laid-open No. 2001-196335, the restriction relating to the contact of the electrode with a wafer makes it necessary to use electropolishing by a polishing pad and a counter electrode smaller than the area of the wafer to be processed. This leads to a lowering in the polishing rate of the whole wafer surface. Besides, since an electropolishing liquid supply hole or holes formed in the counter electrode affect the uniformity of polishing, the polishing sequence is complicated in order to remove the influence and to enhance the uniformity of polishing.

In addition, in the electropolishing apparatus as described in Japanese Patent Laid-open No. 2002-254248, the configuration of the apparatus is complicated. On the other hand, in the polishing method as described in Japanese Patent No. 3125049, the area of anodic oxidation is extremely small, which leads to the serious problem that the polishing rate for forming a trench wiring is lowered. Besides, on a polishing process basis, supply of only the electropolishing liquid as well as a supply balance and a flow rate control as to the electropolishing liquid and free abrasive grains is needed. In addition, in the case of a continuous treatment of wafers, for reducing dispersions among the wafers it is necessary to perform such a control as to make as uniform as possible the pad surface condition after polishing the individual wafer.

### SUMMARY OF THE INVENTION

It is an object of the present invention to provide an electropolishing apparatus and a polishing method, which dissolve the above-mentioned problems of the related art.

In order to attain the above object, according to one aspect of the present invention, there is provided an electropolishing apparatus including a polishing surface plate including a cathode and turnably disposed, a polishing pad disposed on the polishing surface plate, to be impregnated with an electropolishing liquid, and showing electric conduction from the face side to the back side thereof in the state of being impregnated with the electropolishing liquid, a substrate holding unit for holding a work substrate with a work surface of the work substrate opposed to a polishing surface of the polishing pad, the substrate holding unit turnably disposed at a position opposed to the polishing pad, an anode to be brought into contact with the work surface of the work substrate held by the substrate holding unit, a chemical liquid supply unit for supplying a chemical liquid used for polishing onto the polishing pad, and a power source for supplying electric power between the cathode and the anode. Preferably, the chemical liquid supply unit includes a chemical liquid control unit for individually controlling the quantities of the electropolishing liquid, free abrasive grains, and pure water supplied, and means for supplying the electropolishing liquid, the free abrasive grains, and pure water in the quantities controlled by the chemical liquid control unit.

In the electropolishing apparatus according to the present invention, the electropolishing liquid is dropped to a roughly central portion of the polishing pad, then, while moving in the outer circumferential direction of the polishing pad under rotation of the polishing pad about its axis, impregnates the polishing pad therewith, and finally, enters between the cathode and the anode (the work substrate in contact with the anode), to contribute to electropolishing. The electropolishing liquid is dropped in the state of being divided into an electrolytic liquid and free abrasive grains, whereby the work surface of the work substrate undergoes electropolishing and polishing by the free abrasive grains. In this case, the separation of the free abrasive grains is obviated, and the life of the electropolishing liquid is prolonged. In addition, since the polishing pad is turnable and it is turned when the chemical liquid is supplied, the chemical liquid supplied onto the polishing pad is discharged from the outer circumferential direction of the polishing pad to the outside of the polishing pad by a centrifugal force. Further, immediately before the polishing process is finished, the dropping quantity of the free abrasive grains may be reduced, whereby dishing and erosion of a wiring can be reduced to an extreme extent. Furthermore, since the electropolishing apparatus has a structure in which pure water can be dropped solely, it is possible to conduct water polishing, to raise the resistance of the electrolytic liquid, and to discharge unrequired abrasive grains to the outside of the polishing pad.

Besides, according to the electropolishing apparatus of the present invention, the configuration of the apparatus is simplified, as compared with a conventional polishing apparatus in which the electrolytic liquid is supplied from the counter electrode side. In addition, the times required for introducing and discharging the electropolishing liquid can be largely shortened and the throughput of polishing can be greatly enhanced, as compared with the conventional electropolishing apparatus of the type in which electropolishing is conducted while immersing the work in the electropolishing liquid. Further, since water polishing can be introduced after the polishing, it is possible to restrain the deposition of the abrasive grains adhering to the polishing pad surface and of by-products formed by electrolysis, to prolong the life of the polishing pad, and to keep constant the polishing characteristics in the case of a continuous treatment.

According to another aspect of the present invention, there is provided a polishing method including the steps of disposing, on a polishing surface plate including a cathode and turnably disposed, a polishing pad to be impregnated with an electropolishing liquid, the polishing pad showing electric conduction from the face side to the back side thereof in the state of being impregnated with the electropolishing liquid, and holding a work substrate by a substrate holding unit which is turnably disposed, with a work surface of the work substrate opposed to the polishing pad, thereafter supplying a chemical liquid used for polishing onto the polishing pad to impregnate the polishing pad the said chemical liquid, and bringing an anode into contact with the work surface of the work substrate held by the substrate holding unit, turning the polishing pad and the work substrate while maintaining the work surface of the work substrate in contact with a polishing surface of the polishing pad, and supplying electric power between the cathode and the anode, to thereby polish the work surface of the work substrate.

In the polishing method according to the present invention, at the time of polishing the work surface of the work substrate, an organic complex present in the electropolishing liquid and the metal ions of the work substrate dissolved by electrolysis react with each other to produce an insoluble compound, and the insoluble compound is removed by polishing with the free abrasive grains. The removal of the insoluble compound dissolves the steps present in the surface of the work substrate attendant on an increase in the current density in the electropolishing liquid, resulting in that a planar surface can be created.

Besides, according to the polishing method of the present invention, since chemical mechanical polishing is conducted after the electropolishing, it is possible to perform polishing at a polishing rate lower than that of the electropolishing, and to easily polish an extremely thin film by a desired thickness. Further, since polishing by use of pure water is conducted after the chemical mechanical polishing, it is possible to restrain the change with time of the polishing pad by ensuring that a high-concentration electropolishing liquid is not left on the work substrate and by lowering the concentration of the electropolishing liquid with which the polishing pad is impregnated. As a result, it is possible to prolong the life of the polishing pad, and to keep constant the polishing characteristics in the case of a continuous treatment.

### BRIEF DESCRIPTION OF THE DRAWINGS

These and other objects of the invention will be seen by reference to the description, taken in connection with the accompanying drawing, in which:

FIG. 1 is a schematic configuration view showing one embodiment of the electropolishing apparatus according to the present invention;

FIGS. 2A to 2E are illustrations of a polishing sequence, showing one embodiment of the polishing method according to the present invention; and

FIG. 3 is a diagram showing the polishing sequence, showing one embodiment of the polishing method according to the present invention.

### DETAILED DESCRIPTION OF THE PREFERRED EMBODIMENTS

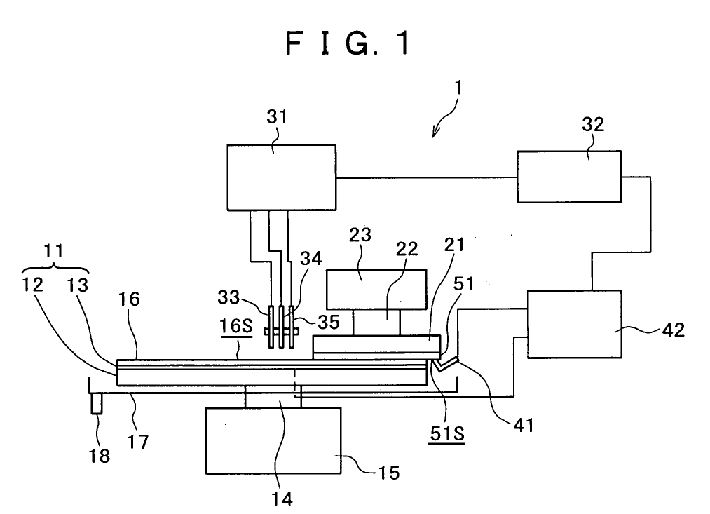

As shown in FIG. 1, a polishing surface plate 11 to be a cathode is disposed turnably. The polishing surface plate 11 is composed of a base 12 and a cathode 13 disposed on the base 12. Alternatively, the polishing surface plate 11 may be formed as a cathode as a whole. The cathode 13 is formed of an electric conductor; here, a copper plate is adopted. Besides, an electrically conductive corrosion preventive film (not shown) may be formed on the surface of the cathode 13, for protection from corrosion with a polishing liquid or the like. A motor 15 as a turning means is provided for the polishing surface plate 11, with a rotary shaft 14 therebetween.

On the polishing surface plate 11, there is disposed a polishing pad 16 to be impregnated with an electropolishing liquid and showing electric conduction from the face side to the back side thereof in the state of being impregnated with the electropolishing liquid. The polishing pad 16 is formed, for example, of an open-cell foamed resin of polyvinyl formal in which, for example, pores with a diameter of 60 to 90 μm are present in a porosity of about 90% and which has a Young's modulus in wet condition of 30 MPa and a thickness of 4 to 5 mm. The material of the polishing pad 16 is not limited to the open-cell foamed resin of polyvinyl formal, and the pore diameter and the porosity are not limited to the above-mentioned numerical values; namely, the polishing pad may be any one that can be impregnated with the electropolishing liquid and that shows electric conduction from the face side to the back side thereof in the state of being impregnated with the electropolishing liquid. The polishing surface plate 11 (the base 12 and the cathode 13) and the polishing pad 16 each preferably have a diameter of not less than two times the diameter of a work substrate 51 to be polished.

Further, a cup 17 for receiving the chemical liquid discharged from the top of the polishing pad 16 is disposed around the side periphery and on the bottom side of the polishing surface plate 11, and the cup 17 is provided with a chemical liquid discharge portion 18 at a position lower than the polishing surface plate 11.

At a position on the upper side of and opposed to the polishing pad 16, there is provided a substrate holding unit 21 which is for holding the work substrate 51 with a work surface 51S of the work substrate 51 opposed to a polishing surface 16S of the polishing pad 16 and which is disposed turnably. A motor 23 as a turning means is provided for the substrate holding unit 21, with a rotary shaft 22 therebetween. The motor 23 is so controlled that the work substrate 51 is rotated at a speed of 30 to 70 rpm, for example. Though not shown in the figure, a mechanism for holding the work substrate 51, of the substrate holding unit 21, is a vacuum chuck, for example, and it is so constructed that it can be raised and lowered so that the work substrate 51 in a face-down condition can be brought into contact with the polishing pad 16. In addition, a lift means for raising and lowering the substrate holding unit 21 may be provided. Further, a pressure regulating means may be provided for regulating the pressure with which the work substrate 51 is pressed against the polishing pad 16. Since this pressure affects the polishing characteristics (particularly, polishing rate), it is necessary that the pressure can be controlled accurately. The work substrate 51 in this case is brought into contact with the polishing pad 16 while being rotated about its axis.

On the upper side of a central portion of the polishing pad 16, there is disposed a chemical liquid supply unit 31 for supplying a chemical liquid used for polishing. The chemical liquid supply unit 31 includes a chemical liquid control unit 32 for individually controlling the quantities of the electropolishing liquid, free abrasive grains, and pure water supplied, and means for supplying the electropolishing liquid, the free abrasive grains, and pure water in the quantities controlled by the chemical liquid control unit 32. Therefore, nozzles 33, 34, and 35 for supplying the electropolishing liquid, the free abrasive grains, and pure water onto the polishing pad 16 are connected to the chemical liquid supply unit 31.

An anode 41 is so disposed as to make contact with the work surface 51S of the work substrate 51 held by the substrate holding unit 21. Therefore, the work substrate 51 is so disposed that the work substrate 51 will make contact with the anode 41, i.e., an outer circumferential portion of the work substrate 51 will be located outside the polishing pad 16. Furthermore, a power source 43 is provided for supplying electric power to the cathode (the polishing surface plate 11) and the anode 41. The power source 43 may be one which can control an impressed voltage in conjunction with the quantity of the chemical liquid supplied.

In the above electropolishing apparatus 1, the electropolishing liquid is dropped onto a roughly central portion of the polishing pad 16, then impregnates the polishing pad 16 therewith while moving in the outer circumferential direction of the polishing pad 16 under the rotation of the polishing pad 16 about its axis, and finally, enters between the cathode 13 and the work substrate 51 (anode) kept in contact with the anode 41, to contribute to electropolishing. In addition, the electropolishing liquid is dropped in the state of being divided into an electrolytic liquid and free abrasive grains, whereby the work surface 51S of the work substrate 51 is subjected to electropolishing and to polishing by the free abrasive grains. In this case, the separation of the free abrasive grains is obviated, so that the life of the electropolishing liquid is prolonged greatly.

Besides, since the polishing pad 16 is turnable and is turned when the chemical liquid is supplied, the chemical liquid supplied onto the polishing pad 16 is discharged from the outer circumferential direction of the polishing pad 16 to the outside of the polishing pad 16 under a centrifugal force.

Furthermore, by reducing the dropping quantity of the free abrasive grains immediately before the polishing process is finished, dishing and erosion of a wiring can be reduced to an extreme extent in the polishing in which a surplus wiring material layer in forming a trench wiring is removed. In addition, since a structure in which pure water can be dropped solely is provided, it is possible to apply water polishing, and it is further possible to raise the resistance of the electrolytic liquid, and to discharge the unrequired abrasive grains to the outside of the polishing pad 16. Furthermore, the dropping quantity of the chemical liquid dropped from the chemical liquid supply unit 31 is optimized by the chemical liquid control unit 32, whereby it is possible to reduce the quantities of the electropolishing liquid, the free abrasive grains, pure water, and the like which are supplied.

In ordinary electropolishing, polishing is generally conducted under the condition where the work and a cathode are immersed in an electrolytic liquid. In the electropolishing apparatus 1 according to the present invention, on the other hand, the electropolishing liquid having served for polishing and coming to the outside of the polishing pad 16 is received by the cup 17, to be discharged through the chemical liquid discharge portion 18. Therefore, the electropolishing liquid discharged to the outside of the polishing pad 16 will not enter between the polishing pad 16 and the work substrate 51.

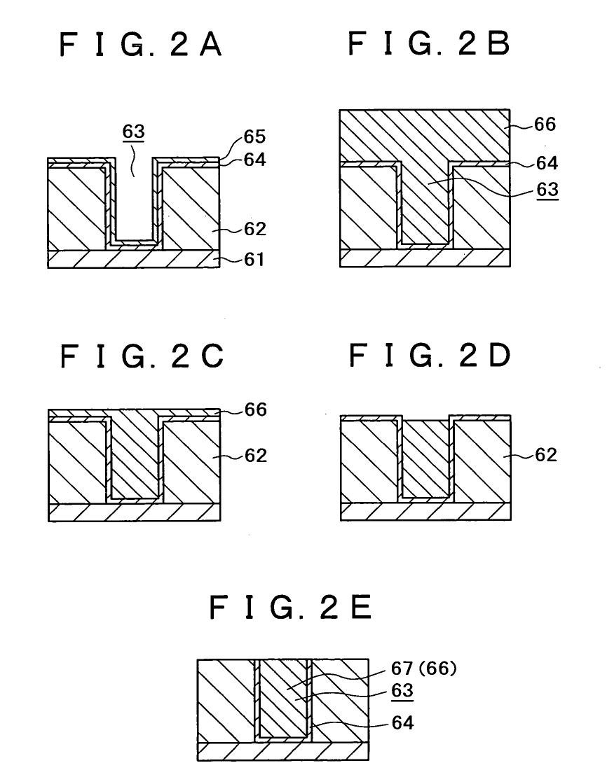

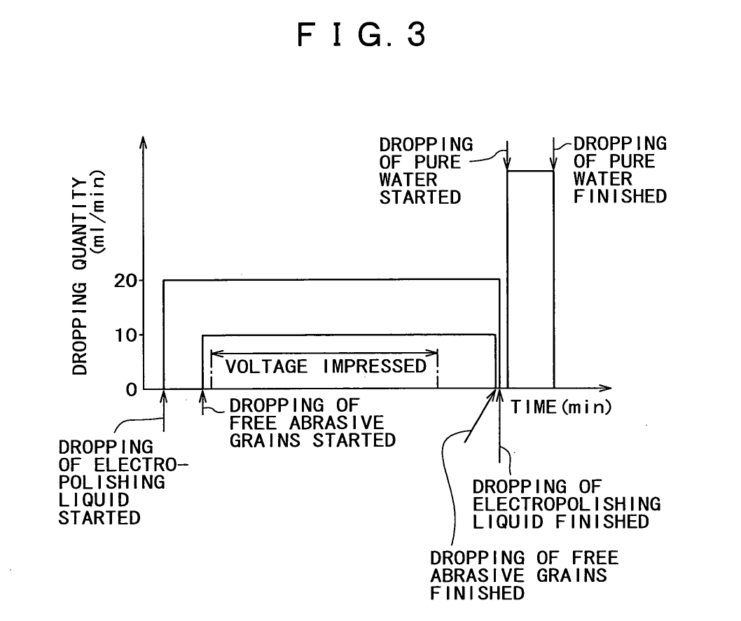

Next, one embodiment of the polishing method according to the present invention will be described referring to illustrations of a polishing sequence shown in FIG. 2 and to FIG. 1. A process for forming a trench wiring by applying the polishing method of the present invention is illustrated by sectional views in FIGS. 2A to 2E, and the polishing process is illustrated by the diagram in FIG. 3.

As shown in FIG. 2A, a second insulation film 62 is formed on a first insulation film 61 formed on a substrate. The second insulation film 62 is provided with a wiring trench 63. In this condition, a barrier metal layer 64 and a copper seed layer 65 are sequentially laminatedly formed on the inside surfaces of the wiring trench 63 and on the surface of the second insulation film 62 by PVD, for example. The barrier metal layer 64 is composed, for example, of a tantalum (Ta) film, a tantalum nitride (TaN) film, or a laminated film thereof.

Next, as shown in FIG. 2B, a copper film 66 is formed by electroplating on the surfaces of the copper seed layer 65 (see FIG. 2A) so as to fill up the wiring trench 63, with the barrier metal layer 64 therebetween. In the figure, the copper film 66 is drawn in the state of including the copper seed layer 65 therein.

Thereafter, the copper film 66 is polished. The polishing is conducted by use of the electropolishing apparatus 1 which has been described above referring to FIG. 1. First, the work substrate 51 provided with the copper film 66 is attached to the substrate holding unit 21, with the copper film 66 opposed to the polishing pad 16. On the other hand, the polishing pad 16 to be impregnated with the electropolishing liquid and showing electric conduction from the face side to the back side thereof in the state of being impregnated with the electropolishing liquid is disposed on the polishing surface plate 11 which is to be the cathode 13 and which is disposed turnably.

Thereafter, the chemical liquid used for polishing is supplied onto the polishing pad 16 to impregnate the polishing pad 16 with the chemical liquid, the anode 44 is brought into contact with the copper film 66 constituting the work surface of the work substrate 51 held by the substrate holding unit 21, the polishing pad 16 and the work substrate 51 are turned while keeping the copper film 66 in contact with the polishing surface 16S of the polishing pad 16, and electric power is supplied between the cathode 13 and the copper film 66 (anode) kept in contact with the anode 41, to electropolish the copper film 66.

Specifically, the work substrate 51 is sucked onto the substrate holding unit 21. In addition, the electropolishing liquid is dropped from the chemical liquid supply unit 31 onto the polishing pad 16. In this case, for example, a mixed liquid of an aqueous solution of quinaldinic acid (1 wt %) and nitric acid is used as the electropolishing liquid, the dropping quantity is about 100 cc, and the polishing pad 16 is impregnated sufficiently with the electropolishing liquid. Thereafter, the dropping quantity was changed to 20 ml/min, as an example. The dropping quantity can be appropriately changed according to the material of the work, the polishing rate, etc. However, in order to prevent the shearing force between the polishing pad 16 and the work substrate 51 from rising to cause a trouble in polishing, it is necessary to set the dropping quantity to be not less than 15 ml/min, and a dropping quantity of about 20 ml/min is sufficient. From the viewpoint of minimizing the consumption of the electropolishing liquid, it is preferable that the upper limit of the dropping quantity is 20 ml/min, and the maximum of the dropping quantity taking the variations of the dropping quantity into account is 25 ml/min. After the polishing pad 16 is impregnated with the electropolishing liquid, free abrasive grains (a polishing liquid containing a polishing slurry) are dropped onto the polishing pad 16. Colloidal alumina (15%), for example, was used as the free abrasive grains, and the dropping quantity was set at 10 ml/min, as an example. The dropping quantity can be appropriately changed according to the material of the work, the polishing rate, etc. As a result, the electropolishing liquid and the free abrasive grains are supplied onto the polishing pad 16.

Thereafter, electric power (voltage) is impressed between the cathode 13 and the copper film 66 (anode) kept in contact with the anode 41, to conduct electropolishing (e.g., DC electropolishing) of the copper film 66. The impressed voltage in this case is set in the range of 0.5 to 1.0 V, for example.

During the electropolishing, the electrolytic current is monitored. Then, the impression of voltage is finished when a current of 1/10 times that at the start of polishing is reached. Alternatively, the impression of voltage is finished when a predetermined electric energy is reached. In this instance, the copper film 66 in a thin form is left on the second insulation film 62 (the condition shown in FIG. 2C).

With the impression of voltage thus stopped, the polishing process thereafter enters an ordinary chemical mechanical polishing by use of the electropolishing liquid and the free abrasive grains. Namely, the copper film 66 is further polished at a lower polishing rate by the action of an oxidizing agent mixed in the electropolishing liquid. That is, the copper film 66 is polished by the ordinary Chemical Mechanical Polishing (CMP) from this time on. Under this polishing condition, the copper film 66 (inclusive of the copper seed layer 65) on the second insulation film 62 is completely polished away. Then, when the copper film 66 on the second insulation film 62 has been removed (the condition of FIG. 2D), the dropping of the free abrasive grains is finished. Further, the supply of the electropolishing liquid is finished. Next, pure water is dropped for the purpose of completely stopping the chemical mechanical polishing of the copper film 66.

Subsequently, after the removal of the slurry is confirmed, water polishing under this condition is continued for a predetermined period of time. For example, polishing with only pure water is conducted for 30 sec. The water polishing results in that the high-concentration electropolishing liquid is not left on the work substrate 51 and that the concentration of the electropolishing liquid with which the polishing pad 16 is impregnated is lowered, whereby change with time of the polishing pad 16 can be restrained.

Subsequently, in view of the copper film 66 remaining at the portion having been in contact with the anode 41, a sulfuric acid solution or the like is made to act on the contact portion to remove the unrequired copper film 66 through wet etching. Further, in view of the barrier metal layer 64 present on the work substrate 51, the barrier metal layer 64 is removed by dry etching or CMP, whereby a copper wiring 67 composed of the copper film 66 remaining inside the wiring trench 63 with the barrier metal layer 64 therebetween is completed, as shown in FIG. 2E.

In the above-described polishing method, the method for supplying the electropolishing liquid (inclusive of the oxidizing agent) and the free abrasive grains may be a method of supplying them through separate nozzles or a method of supplying them through a single nozzle, provided that the flow rates of the electropolishing liquid (inclusive of the oxidizing agent) and the free abrasive grains are controlled individually.

While preferred embodiments of the invention have been described using specific terms, such description is for illustrative purposes only, and it is to be understood that changes and variations may be made without departing from the spirit or scope of the following claims.

What is claimed is:

1. An electropolishing apparatus comprising:
a polishing surface plate including a cathode and turnably disposed;
a polishing pad disposed on said polishing surface plate, to be impregnated with an electropolishing liquid, and showing electric conduction from the face side to the back side thereof in the state of being impregnated with said electropolishing liquid;
a substrate holding unit for holding a work substrate with a work surface of said work substrate opposed to a polishing surface of said polishing pad, said substrate holding unit turnably disposed at a position opposed to said polishing pad;
an anode to be brought into contact with said work surface of said work substrate held by said substrate holding unit;
a chemical liquid supply unit for supplying a chemical liquid used for polishing onto said polishing pad; and
a power source for supplying electric power between said cathode and said anode.

2. The electropolishing apparatus as set forth in claim 1, wherein
said chemical liquid supply unit comprises: a chemical liquid control unit for individually controlling the quantities of said electropolishing liquid, free abrasive grains, and pure water supplied; and
means for supplying said electropolishing liquid, said free abrasive grains, and pure water in the quantities controlled by said chemical liquid control unit.

3. The electropolishing apparatus as set forth in claim 1, further comprising:
a cup for receiving a chemical liquid discharged from the top of said polishing pad, said cup provided around the side periphery of said polishing surface plate and on the bottom side of said polishing surface plate, and
a chemical liquid discharge unit provided in said cup at a position lower than said polishing surface plate.

4. A polishing method comprising the steps of:
disposing, on a polishing surface plate including a cathode and turnably disposed, a polishing pad to be impregnated with an electropolishing liquid, said polishing pad showing electric conduction from the face side to the back side thereof in the state of being impregnated with said electropolishing liquid, and holding a work substrate by a substrate holding unit which is turnably disposed, with a work surface of said work substrate opposed to said polishing pad;
thereafter supplying a chemical liquid used for polishing onto said polishing pad to impregnate said polishing pad with said chemical liquid; and
bringing an anode into contact with said work surface of said work substrate held by said substrate holding unit, turning said polishing pad and said work substrate while maintaining said work surface of said work substrate in contact with a polishing surface of said polishing pad, and supplying electric power between said cathode and said anode, to thereby polish said work surface of said work substrate.

5. The polishing method as set forth in claim 4, wherein
after electropolishing by use of said electropolishing liquid and free abrasive grains is conducted, the supply of electric power between said cathode and said anode is stopped, and
chemical mechanical polishing of said work surface of said work substrate is subsequently conducted by use of said polishing pad.

6. The polishing method as set forth in claim 5, wherein
after said chemical mechanical polishing is conducted,
the supply of said electropolishing liquid and said free abrasive grains is stopped, and
thereafter finish polishing of said work surface of said work substrate is conducted while supplying pure water onto said polishing pad.
